(19) United States
(12) Patent Application Publication
(10) Pub. No.: US 2018/0240419 A1
(43) Pub. Date: Aug. 23, 2018

(54) INFORMATION PROCESSING APPARATUS AND INFORMATION PROCESSING METHOD

(71) Applicant: CANON KABUSHIKI KAISHA, Tokyo (JP)

(72) Inventor: Mitsuru Tada, Machida-shi (JP)

(21) Appl. No.: 15/890,571

(22) Filed: Feb. 7, 2018

(30) Foreign Application Priority Data
Feb. 17, 2017 (JP) 2017-028065

(51) Int. Cl. G09G 3/36; G02F 1/1335; G09G 3/34

(52) U.S. Cl. CPC G09G 3/3607; G02F 1/133611; G09G 3/3413; G09G 2320/0233; G09G 2320/0666; G02F 2001/133601; G09G 2320/0646

(57) ABSTRACT

An information processing apparatus includes: as acquiring unit configured to acquire, based on image data for a display apparatus, at least one profile data on a brightness distribution of light, which is emitted from a light source unit of the display apparatus and is irradiated to a display unit of the display apparatus, as at least one profile data corresponding to a plurality of light source units of the display apparatus; and a generating unit configured to generate a correction parameter for correcting brightness of the image data, based on the at least one profile data and emission brightness of each of the plurality of light source units.

### BACKGROUND OF THE INVENTION

### Field of the Invention

The present invention relates to an information processing apparatus and an information processing method.

### Description of the Related Art

As a technique related to a liquid crystal display apparatus, a technique to independently control the emission brightness of each light source unit of the backlight unit based on the input image data is known (Japanese Patent Application Publication No. 2012-093786). This type of control is called “local dimming control”.

In some cases of performing the local dimming control, the brightness distribution of the light, which is emitted from the backlight unit and is irradiated to the rear face of the liquid crystal panel (irradiated light), is estimated, and the brightness of the input image data is corrected based on the estimated brightness distribution.

The light emitted from the light source unit is reflected by optical members (reflection plate, reflection sheet, diffusion plate, diffusion sheet), a liquid crystal panel and the like, and is diffused far and wide When the brightness distribution of the irradiated light is estimated, this diffusion may be considered.

Further, the intensity of the light which is reflected on the liquid crystal panel without transmitting through the liquid crystal panel (panel-reflected light) changes depending on the transmittance of the liquid crystal panel. Therefore if the transmittance of the liquid crystal panel changes, the intensity of the panel reflected light changes, and the profile of the brightness distribution of the irradiated light also changes.

### SUMMARY OF THE INVENTION

However, in the prior art, the profile change (change in the profile of the brightness distribution of the irradiated light) caused by the change the transmittance of the liquid crystal panel is not considered. Therefore if the transmittance of the liquid crystal panel changes, the brightness distribution of the irradiated light cannot be accurately estimated, and the brightness of the image data cannot be accurately corrected.

The present invention in its first aspect provides an information processing apparatus configured to generate a correction parameter for correcting brightness of image data for a display apparatus which includes a light-emitting unit including a plurality of light source units, and a display unit configured to display an image on a screen by transmitting light emitted from the light-emitting unit based on the image data, the information processing apparatus comprising:

an acquiring unit configured to acquire, based on the image data, at least one profile data on a brightness distribution of light, which is emitted from the light source unit and is irradiated to the display unit, as at least one profile data corresponding to the plurality of light source units; and

a generating unit configured to generate the correction parameter based on the at least one profile data and emission brightness of each of the plurality of light source units.

The present invention in its second aspect provides the display apparatus comprising the above mentioned information processing apparatus.

The present invention in its third aspect provides an information processing method for generating a correction parameter for correcting brightness of image data for a display apparatus which includes a light-emitting unit including a plurality of light source units, and a display unit configured to display an image on a screen by transmitting light emitted from the light-emitting unit based on the image data, the information processing method comprising:

acquiring, based on the image data, at least one profile data on a brightness distribution of light, which is emitted from the light source unit and is irradiated to the display unit, as at least one profile data corresponding to the plurality of light source units; and

generating the correction parameter based on the at least one profile data and emission brightness of each of the plurality of light source units.

The present invention in its fourth aspect provides a non-transitory computer readable medium that stores a program, wherein

the program causes a computer to execute an information processing method for generating a correction parameter for correcting brightness of image data for a display apparatus which includes a light-emitting unit including a plurality of light source units, and a display unit configured to display an image on a screen by transmitting light emitted from the light-emitting unit based on the image data,

the information processing method includes:

acquiring, based on the image data, at least one profile data on a brightness distribution of light, which is emitted from the light source unit and is irradiated to the display unit, as at least one profile data corresponding to the plurality of light source units; and

generating the correction parameter based on the at least one profile data and emission brightness of each of the plurality of light source units.

Further features of the present invention will become apparent from the following description of exemplary embodiments with reference to the attached drawings.

### BRIEF DESCRIPTION OF THE DRAWINGS

FIG. 1 is a block diagram depicting a configuration example of a liquid crystal display apparatus according to Examples 1 and 2;

FIG. 2 is a schematic diagram depicting an example of the change in the brightness distribution of the irradiated light according to Examples 1 and 2;

FIG. 3 is a schematic diagram depicting an example of the comparison result between the prior art and Example 1;

FIG. 4 is a schematic diagram depicting an example of a plurality of divided regions according to Examples 1 and 2; and

FIGS. 5A and 5B are schematic diagrams depicting examples of profile data according to Examples 1 and 2.

### DESCRIPTION OF THE EMBODIMENTS

### EXAMPLE 1

Example 1 of the present invention will be described. The following description concerns an example when an information processing apparatus, according to this example, is included in a display apparatus which displays an image on the screen by transmitting light emitted from a light-emitting unit based on the input image data. However, the information processing apparatus may be an apparatus that is separate from the display apparatus.

For example, the information processing apparatus may be a personal computer (PC) that is separate from the display apparatus. The information processing apparatus generates correction, parameters to correct the brightness of the input image data of the display apparatus.

An example of using a transmission type liquid crystal display apparatus as the display apparatus will be described below. However, the display apparatus may be any apparatus as long as an image can be displayed on the screen, by transmitting light emitted from the light-emitting unit based on the input image data.

For example, a micro electro mechanical system (MEMS) shutter type display apparatus, which uses MEMS shutters instead of the liquid crystal elements, may be used. The display apparatus may be a color display apparatus (a display apparatus which can display color images) or may be a monochrome display apparatus (a display apparatus which can display only monochrome images).

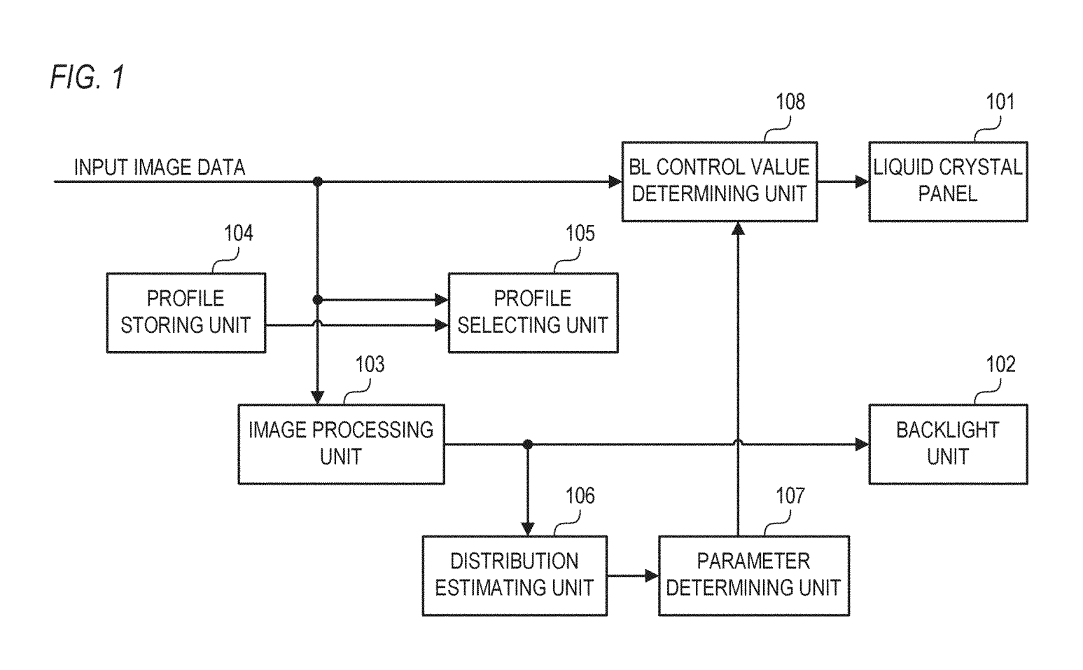

FIG. 1 is a block diagram depicting a configuration example of the liquid crystal display apparatus according to this example. The liquid crystal display apparatus according to this example includes: a liquid crystal panel 101; a backlight unit 102; a BL control value determining unit 103; a profile storing unit 104; a profile selecting unit 105; a distribution estimating unit 106; a parameter generating unit 107; and an image processing unit 108.

The backlight unit 102 is a light-emitting unit which includes a plurality of light source units. For the light source unit, at least one light-emitting element is used. For the light-emitting element, a light-emitting diode (LED), an organic EL element, a semiconductor laser, a plasma element, a cold cathode fluorescent lamp (CCFL) or the like is used. The light emitted from the backlight unit 102 is irradiated to the rear face of the liquid crystal panel 101. The liquid crystal panel 101 is a display unit which displays an image on the screen by transmitting the light emitted from the backlight unit 102 based on the input image data. Each functional unit in FIG. 1 will be described in detail later.

Effect of Example 1

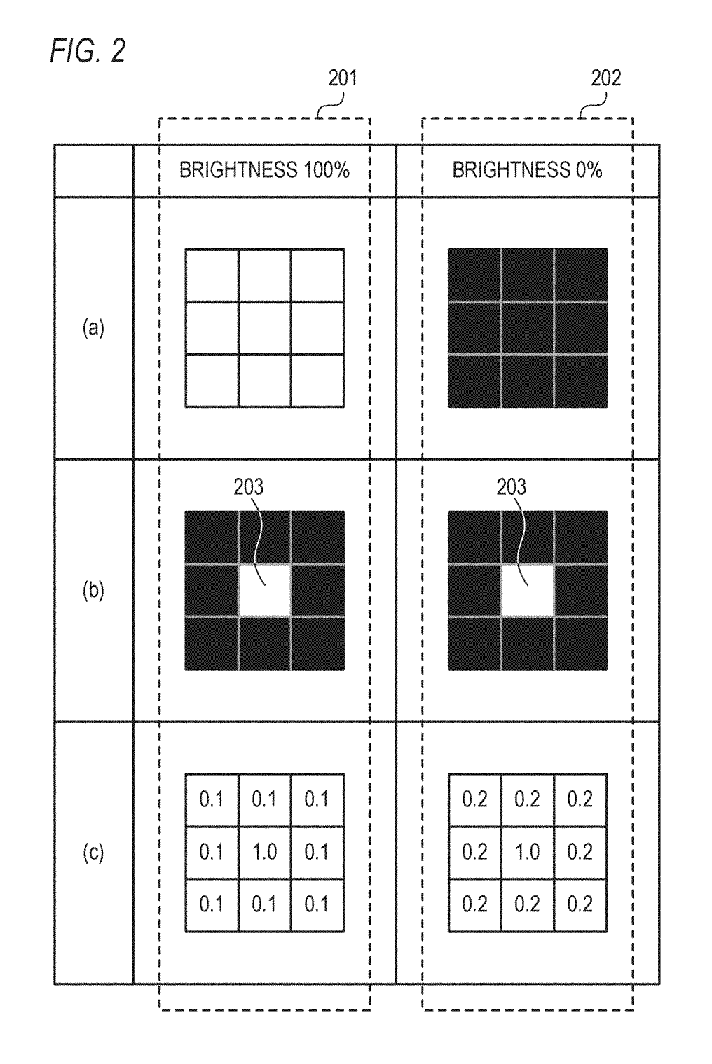

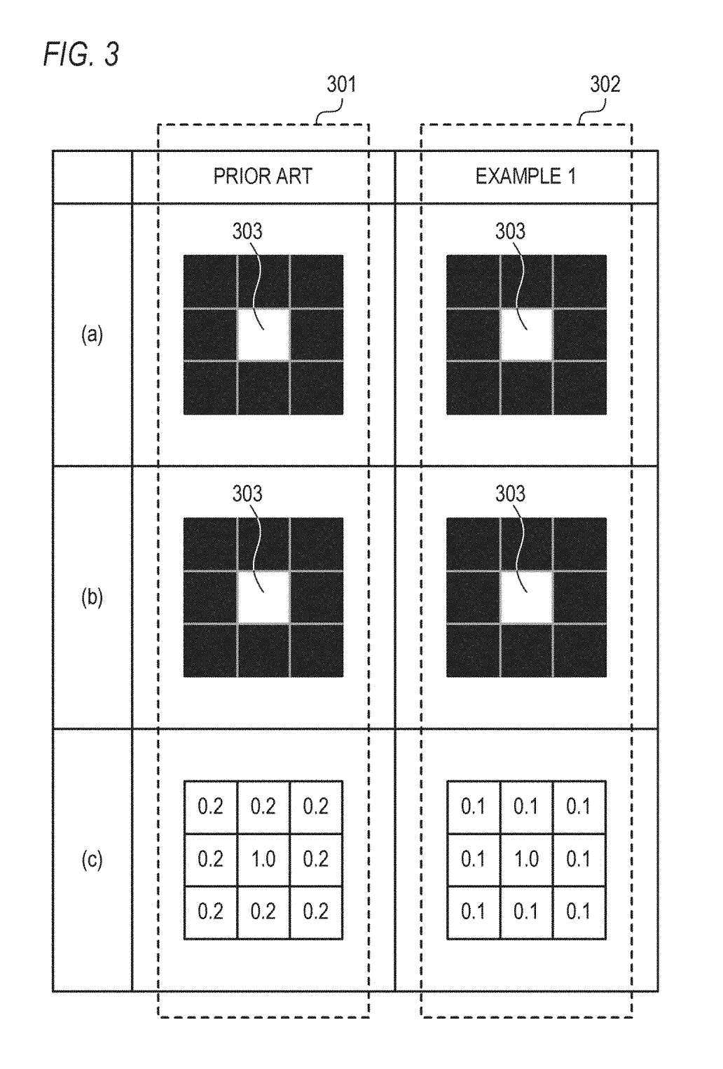

The effect of Example 1 will be described with reference to FIGS. 2 and 3. The light emitted from the light source unit is reflected by the optical members (reflection plate, reflection sheet, diffusion plate, diffusion sheet), the liquid crystal panel 101 and the like, and is diffused far and wide. The intensity of light, which is reflected on the liquid crystal panel 101 without transmitting through the liquid crystal panel 101 (panel-reflected light), changes depending on the transmittance of the liquid crystal panel 101. Therefore if the transmittance of the liquid crystal panel 101 changes, the intensity of the panel reflected light changes, and the profile of the brightness distribution of the irradiated light (light which is emitted from the backlight unit 102, and is irradiated to the liquid crystal panel 101) also changes.

FIG. 2 is a schematic diagram depicting an example of the relationship between the transmittance of the liquid crystal panel 101 and the brightness distribution of the irradiated light. In Example 1, a plurality of light source units correspond to a plurality of divided regions constituting the screen respectively. “A divided region” is “a subregion which is a partial region of the screen”. In FIG. 2, the nine divided regions (arranged in 3 rows×3 columns), which correspond to the nine light source units (arranged in 3 rows×3 columns) respectively, are illustrated. The left column 201 in FIG. 2 indicates the case when the brightness of the input image data is 100%, and the right column 202 indicates the case when the brightness of the input image data is 0%.

(a) of FIG. 2 indicates the transmittance of the liquid crystal panel 101. In (a) of FIG. 2, the transmittance is indicated so that the color changes from black to white as the transmittance increases. The transmittance in the left column 201 is lower than the transmittance in the right column 202. (b) of FIG. 2 indicates the emission brightness of the light source unit. In (b) of FIG. 2, the emission brightness is indicated so that the color changes from black to white as the emission brightness increases. In both the left column 201 and the right column 202, the light source unit corresponding to the divided region 203 at the center (location in second row and second column) is ON, and the eight light source units corresponding to the remaining eight divided regions respectively are OFF.

(c) of FIG. 2 indicates the brightness distribution of the irradiated light. (c) of FIG. 2 is the brightness distribution of the light which is emitted from the light source unit corresponding to the divided region 203 and is irradiated to the liquid crystal panel 101. In (c) of FIG. 2, the brightness of the irradiated light is normalized such that the brightness in the divided region 203 becomes 1. In the brightness distribution in the left column 201, the brightness n the divided regions surrounding the divided region 203 (that is, the above mentioned eight divided regions) is 0.1. In the brightness distribution in the right column 202, the brightness in the divided regions surrounding the divided region 203 is 0.2. In other words, in the brightness distribution in the right column 202 (the brightness distribution indicated on the right side in (c) of FIG. 2), the brightness in the divided regions surrounding the divided region 203 is higher, compared with the brightness distribution in the left column 201 (the brightness distribution indicated on the left side in (c) or FIG. 2). This means that the spread of the brightness distribution n the right column 202 is larger than the spread of the brightness distribution in the left column 201. In the case when the transmittance of the liquid crystal panel 101 is low, compared with the case when the transmittance of the liquid crystal panel 101 is high, the quantity of light which is emitted from the light source unit and transmits through the liquid crystal panel 101 is low, and the quantity of light which is emitted from the light source unit and is reflected by the liquid crystal panel 101 is high. Therefore the brightness distribution changes as depicted in (c) of FIG. 2.

FIG. 3 is a schematic diagram depicting an example of the comparison result between the prior art and Example 1. In FIG. 3, the nine divided regions (arranged in 3 rows×3 columns), which correspond to the nine light source units (arranged in 3 rows×3 columns) respectively, are illustrated. The left column 301 in FIG. 3 indicates the prior art, and the right column 302 indicates Example 1.

(a) of FIG. 3 indicates the transmittance of the liquid crystal panel 101. In (a) of FIG. 3, the transmittance is indicated so that the color changes from black to white as the transmittance increases. In both the left column 301 and the right column 302, the transmittance in the divided region 303 at the center (located in the second row and second column) corresponds to the input image data of which brightness is 100%, and the transmittance in the remaining eight divided regions corresponds to the input image data of which brightness is 0%. Therefore in both the left column 301 and the right. column 302, the transmittance in the above mentioned eight divided regions is lower than the transmittance in the divided region 303. (b) of FIG. 3 indicates the emission brightness of the light source unit. In (b) of FIG. 3, the emission brightness is indicated so that the color changes from black to white as the emission brightness increases. In both the left column 301 and the right column 302, the light source unit corresponding to the divided region 303 is ON, and the eight light source units corresponding to the remaining eight divided regions respectively are OFF.

(c) of FIG. 3 indicates the estimation result of the brightness distribution of the irradiated light. In (c) of FIG. 3, the brightness of the irradiated light is normalized so that the brightness in the divided region 303 becomes 1. As mentioned above, the transmittance in the divided region 303 corresponds to the input image data of which brightness is 100%. Therefore in the estimation result, a brightness distribution, that is approximately the same as the brightness distribution indicated on the left side in (c) of FIG. 2, should be obtained. Here the meaning of “approximately the same” includes “exactly the same”. In both the prior art and Example 1, the brightness distribution of the irradiated light is estimated using the profile data on the brightness distribution of the light, which is emitted from the light source unit and is irradiated to the liquid crystal panel 101. Then the correction parameter is generated based on the estimation result

In the prior art, fixed profile data, which does not depend on the input image data, is used as the profile data corresponding to each of the plurality of light source units. Here it is assumed that the profile data on the brightness distribution indicated on the right side in (c) of FIG. 2 is used as the profile data which corresponds to the nine light source units respectively. Therefore as the estimation result, a brightness distribution, in which the brightness in the divided regions surrounding the divided region 303 (that is, the above mentioned eight divided regions) is not 0.1 but 0.2, is obtained. In other words, as the estimation result, not the brightness distribution indicated on the left side in (c) of FIG. 2, but the brightness distribution indicated on the right side in (c) of FIG. 2 is acquired. Hence in the case of the prior art, sometimes an accurate estimation result may not be acquired. In other words, sometimes an estimation result having a major error may be obtained in the case of the prior art. As a result, a correction parameter, which cannot accurately correct the brightness of the input image data, may be acquired.

In Example 1, on the other hand, at least one profile data is acquired and used as at least one profile data corresponding to a plurality of light source units based on the input image data. In concrete terms, for each of the plurality of subregions, profile data on the light source unit corresponding to this sub region is acquired based on the input image data on this subregion. As mentioned above, the transmittance in the divided region 303 corresponds to the input image data of which brightness is 100%, and the transmittance in the remaining eight divided regions corresponds to the input image data of which brightness is 0%. Therefore the profile data on the brightness distribution indicated on the left side in (c) of FIG. 2 is used for the light source unit corresponding to the divided region 303, and the profile data on the brightness distribution indicated on the right side in (c) of FIG. 2 s used for the remaining eight light source units. As a result, the brightness distribution, in which brightness in the divided regions surrounding the divided region 303 (that is, the above mentioned eight divided regions) is 0.1, is acquired as the estimation result in other words, the brightness distribution indicated on the left side in (c) of FIG. 2 is acquired as the estimation result. In this way, according to Example 1, a highly accurate estimation result can be obtained. In other words, an estimation result having a minor error alone can be acquired in the case of Example 1. As a result, a correction parameter, which can accurately correct the brightness of the input image data, can be acquired.

Details on Example 1

Each functional unit of the liquid crystal display apparatus according to Example 1 will be described in detail.

Liquid Crystal Panel

As mentioned above, the liquid crystal panel 101 displays an image on the screen by transmitting through the light emitted from the backlight unit 102, based on the input image data. In Example 1, the display image data is generated from the input image data by the image processing unit 108. Then the liquid crystal panel 101 transmits through the light emitted from the backlight unit 102 in accordance with the display image data outputted from the image processing unit 108. The configuration of the liquid crystal panel 101 is not especially limited, but in Example 1, the liquid crystal panel 101 includes three liquid crystal elements (R element corresponding to red, G element corresponding to green, and B element corresponding to blue) for each of the plurality of pixels of the display image data. Then for each of the plurality of pixels of the display image data, the transmittance values of the three liquid crystal elements corresponding to this pixel are independently controlled in accordance with the pixel value of this pixel (pixel value of the display image data).

Backlight Unit

As mentioned above, the backlight unit 102 has a plurality of light source units which correspond to a plurality of divided regions constituting the screen respectively. In Example 1, the emission brightness of each of the plurality of light source units is controlled in accordance with a BL control value bd outputted from the BL control value determining unit 103. The BL control value bd corresponds to the emission brightness (emission intensity) of the light source unit

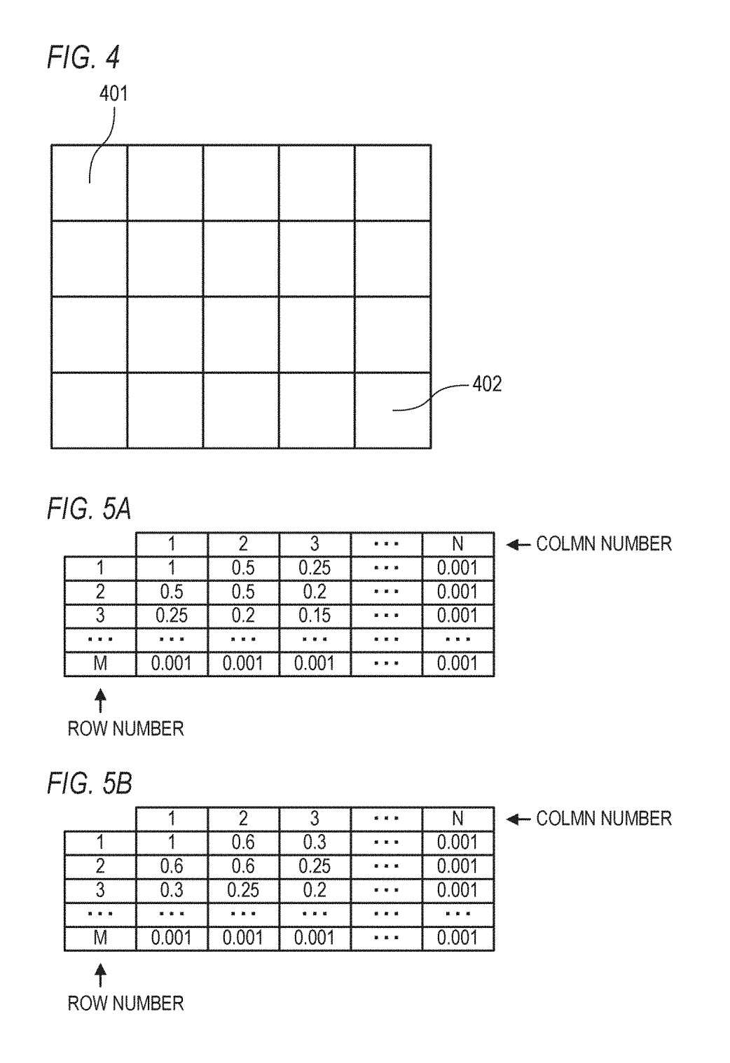

FIG. 4 is a schematic diagram depicting an example of the plurality of divided regions In the example in FIG. 4, the screen is constituted by the 20 divided regions (arranged in 4 rows×5 columns). The backlight unit 102 has the 20 light source units (arranged in 4 rows×5 columns) which correspond to the 20 divided regions (arranged in 4 rows×5 columns) respectively. In Example 1, the BL control value bd of the light source unit, located in the m-th row and the n-th column, is denoted by the “EL control value bdmn”. For example, the BL control value bd of the light source unit corresponding to the divided region 401 located in the first row and the first column is the BL control value bd11, and the EL control value bd of the light source unit corresponding to the divided region 402 located in the fourth row and the fifth column is the EL control value bd45.

BL Control Value Determining Unit

The EL control value determining unit 103 independently controls the emission brightness of each of the plurality of light source units based on the input image data. In this example, for each of the plurality of divided regions, the BL control value determining unit 103 determines the BL control value bd to control the emission brightness of the light source unit corresponding to this divided region, based on the input image data in this divided region. Then the BL control value determining unit 103 outputs a plurality of BL control values bd, which correspond to the plurality of light source units respectively, to the backlight unit 102. The BL control value determining unit 103 also outputs the plurality of BL control values bd to the distribution estimating unit 106.

Method of Determining EL Control Value bd

A concrete example of the method of determining the BL control value bd according to Example 1 will be described

Step 1-1

First, the BL control value determining unit 103 converts each pixel value of the input image data into the brightness value Y. For example, if the pixel values of the input image data are the RGB values (R value, G value, B value)=(R, G, B), the BL control value determining unit 103 calculates the brightness value Y using the following Expression 1, In Expression 1, “α”, “β” and “γ” are predetermined coefficients (brightness conversion coefficients) to convert the RGB values into the Y value. The data format of the input image data is not especially limited. For example, the pixel values of the input image data may be YCbCr values, XYZ tristimulus values or the like.

Y=α×R+β×G+γ×B (Expression 1)

Step 1-2

Then for each of the plurality of divided regions, the BL control value determining unit 103 calculates the average value (average brightness value) YAG of the plurality of brightness values Y in this divided region. In Example 1, the average brightness value YAG corresponding to the divided region located in the m-th row and the n-th column is denoted by the “average brightness value YAGmn”.

Step 1-3

Then for each of the plurality of divided regions, the BL control value determining unit 103 determines the BL control value bd of the light source unit corresponding to this divided region, in accordance with the average brightness value YAG corresponding to this divided region. In Example 1, the BL control value determining unit 103 calculates the BL control value bdmn using the following Expression 2. In Expression 2, “Ymax” denotes the upper limit value of the brightness value Y. In Example 1, the BL control value bd is a value in the 0 to 255 range, and the emission brightness of the light source unit is controlled to be a higher value as the BL control value bd is greater.

Bdmn=YAGmn÷Ymax (Expression 2)

The BL control value bd is not limited to the above mentioned value. For example, the range of the BE control value bd may be wider or narrower than the 0 to 255 range. The BE control value bd may correspond to a lower emission brightness as the BE control value bd is greater. The method of determining the BE control value bd is not limited to the above method. For example, the BE control value bd may be determined using another characteristic value of the input image data. For the other characteristic value, the maximum value of the brightness value Y, the minimum value of the brightness value Y, the median of the brightness value Y, the mode of the brightness value Y, a histogram of the brightness value Y or the like may be used. The average value, the maximum value, the minimum value, the median and the mode are “representative values”. As the other characteristic value, representative value of a gradation value that is different from the brightness value Y, a histogram of a gradation value that is different from the brightness value Y or the like may be used. For the method of determining the BL control value bd, various methods that have been proposed can be used.

Profile Storing Unit

In the profile storing unit 104, a plurality of profile data which correspond respectively to a plurality of possible characteristic values of the input image data are recorded in advance. For the profile storing unit 104, a magnetic disk, an optical disk, a semiconductor memory or the like can be used. The profile storing unit 104 may be included in a display apparatus (information processing apparatus) or may be detachable from the display apparatus

The profile data corresponding to a characteristic value is data (e.g. table, function) on the brightness distribution of the light, which is emitted from the light source unit and is irradiated to the liquid crystal panel 101, in the case when the input image data has this characteristic value. In Example 1, the profile data indicates the brightness F, which is normalized so that the maximum brightness becomes 1, for each of the plurality of divided regions. The brightness F is the brightness of the light, which is emitted from a corresponding light source unit out of the plurality of light source units and is irradiated to the liquid crystal panel 101. In Example 1, when alight source unit corresponding to a divided region on the m-th row and the n-th column is the corresponding light source unit, the brightness F in the divided region on the m′-th row and the n′-th column is denoted by the “brightness Fmnm′n′”.

FIGS. 5A and 5B are examples of the profile data (brightness distribution related to the profile data: distribution of brightness F). FIGS. 5A and 5B show examples when the light source unit, corresponding to the divided region in the first row and the first column, is the corresponding light source unit. The light emitted from the light source unit attenuates as the light becomes more distant from the light source unit. Therefore in FIGS. 5A and 5B, the brightness F is at the maximum (1) in the divided region in the first row and the first column. Then the brightness F decreases as the light becomes more distant from the divided region in the first row and the first column. FIG. 5A indicates the profile data corresponding to the input image data of which brightness is 100%, and FIG. 5B indicates the profile data corresponding to the input image data of which brightness is 0%. In the distribution in FIG. 5B, the brightness F in the divided regions surrounding the divided region in the first row and the first column is high compared with the distribution in FIG. 5A. This means that the spread of the distribution in FIG. 5B is larger than the spread of the distribution in FIG. 5A.

The profile data is not limited to the data indicating, the brightness F in each of the plurality of regions The profile data may be any data, as long as the data is related to the distribution of the brightness F. The range of the brightness F may be wider or narrower than the 0 to 1 range.

The number of characteristic values for which the profile data is provided in advance is not especially limited. For example, the profile data may be provided in advance for all possible characteristic values of the input image data, or the profile data may be provided for a part of possible characteristic values of the input image data.

Further, a plurality of profile data, which correspond to a plurality of light source units respectively, may or may not be provided in advance for one characteristic value. The profile data corresponding to a light source unit is the profile data of which “corresponding light source unit” is this light source unit. The number of profile data corresponding to one characteristic value may be less than the number of the light source units. For example, one profile data may be provided in advance for each of a plurality of characteristic values. At least two profile data, which are less than the number of the light source units, may be provided in advance for each of a plurality of characteristic values. If the number of profile data corresponding to one characteristic value is less than the number of the light source units, one profile data is used as at least two profile data which correspond to at least two light source units respectively. Even if the corresponding light source unit, out of a plurality of light source units, changes, the profile of the distribution of the brightness F does not change very much. Therefore by changing the position of the distribution of the brightness F, at least two profile data, which correspond to at least two light source units respectively, can be acquired from one profile data.

Profile Selecting Unit

The profile selecting unit 105 acquires at least one profile data as at least one profile data corresponding to a plurality of light source units. In Example 1, for each of a plurality of subregions, the profile selecting unit 105 acquires profile data on a light source unit corresponding to each subregion, based on the input image data in this divided region. In concrete terms, the profile selecting unit 105 selects and acquires the profile data corresponding to a characteristic value of the input image data, out of the plurality of profile data stored in the profile storing unit 104. The profile selecting unit 105 performs this processing for each of the plurality of divided regions.

Method of Acquiring Profile Data

A concrete example of a method of acquiring the prof data according to Example 1 will be described.

Step 2-1

For each of a plurality of divided regions, the profile selecting unit 105 calculates the average gradation value (average value of the gradation values) V of the input image data in this divided region. In Example 1, the average gradation value V corresponding to the divided region in the m-th row and the n-th column is denoted by the “average gradation value Vmn”. For example, if the pixel values of the input image data are the RGB values, the profile selecting unit 105 calculates the average gradation value Vmn using the following Expression 3. In Expression 3, “Ri” denotes the R value of the i-th pixel, “Gi” denotes the G value of the i-th pixel, and “Bi” denotes the B value of the i-th pixel. “J” denotes a total number of pixels of the input image data in the divided region in the m-th row and the n-th column.

$$\begin{matrix}[ Math . 1 ] & \\ Vmn = ( {\sum }_{i = 1}^{J} Ri + Gi + Bi ) + J & ( Expression 3 )\end{matrix}$$

Step 2-2

Then for each of the plurality of divided regions, the profile selecting unit 105 selects and acquires profile data, which corresponds to the average gradation value V acquired for this divided region, from the plurality of profile data stored in the profile storing unit 104.

Step 2-3

Then for each of the plurality of divided regions, the profile selecting unit 105 outputs the profile data acquired for this divided region to the distribution estimating unit 106.

The method of acquiring the profile data s not limited to the above method. For example, the profile data may be acquired using another characteristic value of the input image data. For other characteristic values, another representative value of the gradation value, the histogram of the gradations value and the like can be used. At least one of the R value, the U value and the B value need not be used, and a gradation value different from the R value, the G value and the B value (e.g. brightness value Y) may be used.

The profile data may be provided only for one characteristic value, so that the profile data based on the input image data is acquired by correcting the provided profile data. The profile data based on the input image data may be acquired by performing interpolation using a plurality of profile data provided in advance.

Distribution Estimating Unit

The distribution estimating unit 106 estimates the brightness distribution of the irradiated light (light which is emitted from the backlight unit 102 and is irradiated to the liquid crystal panel 101) based on the profile data outputted from the profile selecting unit 105, and the emission brightness of each of the plurality of light source units. In Example 1, for the information on the emission brightness, the distribution estimating unit 106 uses the BL control value bd outputted from the BL control value determining unit 103.

Method of Estimating Brightness Distribution

A concrete example of the method of estimating the brightness distribution according to Example 1 will be described.

Step 3-1

First for each of the plurality of divided regions, by using a light source unit corresponding to this divided region the corresponding light source unit, the distribution estimating unit 106 estimates a partial distribution, which is the brightness distribution of the light which is emitted from the corresponding light source unit and is irradiated to the liquid crystal panel 101. The distribution estimating unit 106 estimates the partial distribution based on the profile data which is acquired by the profile selecting unit 105 for the divided region corresponding to this corresponding source unit, and the BL control value bd of this corresponding light source unit. The partial distribution corresponds to the state where the emission brightness of this corresponding light, source unit is controlled in accordance with the BL control value bd. In Example 1, the brightness of the partial distribution is denoted by “brightness K”. When a light source unit corresponding to the divided region in the m-th row and the n-th column is the corresponding light source unit, the brightness K in the m′-th row and the n′-th column is denoted by “brightness Kmnm′n′”. In Example 1, the distribution estimating unit 106 calculates the brightness Kmnm′n′ using the following Expression 4. Then, to estimate the partial distribution, the distribution estimating unit 106 calculates a plurality of brightness values K, which correspond to the plurality of divided regions respectively.

Kmnm′n′=Fmnm′n′×BDmn (Expression 4)

“BDmn” in Expression 4 denotes the brightness of light which is emitted from the light source unit corresponding to the divided region in the m-th row and the n-th column in accordance with the BL control value bdmn, and is the brightness in the divided region in the m-th row and the n-th column. For example, the brightness BDmn is the brightness on the emission surface of the backlight unit 102, the brightness on the rear face of the liquid crystal panel 101 or the like. The “brightness BDmn” can also be regarded as the “emission brightness corresponding to the BL control value bdmn (emission brightness of the light source unit)”. The method of acquiring the brightness BDmn is not especially limited. For example, the conversion information (e.g. table, function) which indicates the correspondence between the BL control value bdmn and the brightness BDmn is provided in advance, and the distribution estimating unit 106 converts the BL control value bdmn to the brightness BDmn using the conversion information.

Then in the following steps 3-2 and 3-3, the distribution estimating unit 106 estimates the general distribution, which is the brightness distribution of the irradiated light, by combining a plurality of partial distributions which correspond to the plurality of light source units respectively. The general distribution corresponds to the state when the emission brightness of each of the plurality of light source units is controlled in accordance with the BL control value bd.

Step 3-2

In step 3-2, for each of the plurality of divided regions, the distribution estimating unit 106 estimates the brightness of light leaked from another divided region. (leakage brightness) SD, based on the acquired brightness K. In Example 1, the leakage brightness SD in the divided region in the m-th row and the n-th column is denoted by the “leakage brightness SDmn”. In Example the distribution estimating unit 106 calculates the leakage brightness SDmn using the following Expression 5.

$$\begin{matrix}[ Math . 2 ] & \\ SDmn = {\sum }_{\{ {m}^{′} , {n}^{′} : {m}^{′} \neq m {n}^{′} \neq n} {Km}^{′} {n}^{′} mn & ( Expression 5 )\end{matrix}$$

Step 3-3

In step 3-3, the distribution estimating unit 106 estimates the general distribution based on the acquired brightness K and the acquired leakage brightness SD. In Example 1, the brightness of the general distribution is denoted by “brightness T”. The brightness T in the divided region in the m-th row and the n-th column is denoted by “brightness Tmn”. In Example 1, the distribution estimating unit 106 calculates the brightness Tmn using the following Expression 6.

Tmn=Kmnmn+SDmn (Expression 6)

The method of estimating the general distribution is not limited to the above method. For example, the general distribution may be directly estimated from the profile data and the emission brightness of each of the plurality of light source units, without estimating the partial distribution.

Parameter Generating Unit

The parameter generating unit 107 generates the correction parameter U to correct the brightness of the input image data based on the general distribution estimated by the distribution estimating unit 106. The parameter generating unit 107 outputs the generated correction parameter U to the image processing unit 108. In Example 1, a parameter to suppress the change in the display brightness (brightness on the screen), caused by the change in the brightness of the irradiated light from the reference brightness BLYt, is generated as the correction parameter U. The reference brightness BLYt is, for example, the brightness of the irradiated light in the case of not performing the local dimming control.

In concrete terms, for each of the plurality of divided regions, the parameter generating unit 107 generates a gain value, by which the pixel values of the input image data is multiplied, as the correction parameter U, based on the reference brightness BLYt and the brightness T. In Example 1, the correction parameter U in the divided region in the m-th row and the n-th column is denoted by the “correction parameter Umn”. In Example 1, the parameter generating unit 107 calculates the correction parameter Umn using the following Expression 7.

Umn=BLYt÷Tmn (Expression 7)

According to Expression 7, if the brightness Tmn is lower than the reference brightness BLYt, the correction parameter Umn, to increase the brightness of the input image data, is calculated. If the brightness Tmn is higher than the reference brightness BLYt, the correction parameter Umn, to decrease the brightness of the input image data, is calculated.

The region for which the correction parameter U is generated (parameter generating region) is not limited to the divided region. The number of the parameter generating regions may be greater or lesser than the number of divided regions. The size of the parameter generating region may be a size of one pixel, or may be a size of a plurality of pixels. By combining a plurality of brightness values T which correspond to the plurality of divided regions respectively, a brightness T of the parameter generating region, different from that of the divided region, can be acquired. In the same manner, by combining a plurality of correction parameters U which correspond to the plurality of divided regions respectively, a correction parameter U of the parameter generating region different from that of the divided region, can be acquired. Now a case when the brightness T is the brightness at a predetermined position (e.g. center position) of the divided region will be considered. In this case, the brightness T at a position other than the predetermined position can be acquired by interpolation using a plurality of brightness values T which correspond to the plurality of divided regions respectively. In the same manner, the correction parameter U, at a position other than the predetermined position, can be acquired by interpolation using a plurality of correction parameters U which correspond to the plurality of divided regions respectively.

The correction parameter U is not limited to the above mentioned gain value. For example, an offset value, which is added to the pixel values of the input image data, may be generated as the correction parameter U. The reference brightness BLYt is not limited to the above mentioned brightness. The reference brightness BLYt may be the brightness of the irradiated light in the case when the emission brightness of each light source unit is controlled to the upper limit brightness. The reference brightness BLYt may be changed in accordance with the input image data. The reference brightness BLYt may be different among the plurality of parameter generating regions.

The method of generating the correction parameter U is not limited to the above method. For example, the correction parameter U may be directly generated from the profile data and the emission brightness of each of the plurality of light source units, without estimating the general distribution.

Image Processing Unit

The image processing unit 108 generates the display image data by correcting the input image data based on the correction parameter U generated by the parameter generating unit 107. In Example 1, for each of the plurality of divided regions, the image processing unit 108 multiplies each pixel value of the input image data in this divided region by the correction parameter U of this divided region Then the image processing unit 108 outputs the display image data to the liquid crystal panel 101.

As described above, according to Example 1, the profile data is changed and used based on the input image data. Thereby a correction parameter, which accurately corrects the brightness of the input image data, can be acquired as the correction parameter based on the brightness distribution of the irradiated light.

In Example 1, the plurality of subregions are arranged in a matrix, and the shape of the divided region is a square, but the arrangement of the subregions, the shape of the subregion, the number of subregions and the like are not especially limited. In the same manner, the arrangement, of the light source units, the number of light source units and the like are not especially limited either

In Example 1, the subregion is the divided region, but the subregion is not limited to the divided region. For example, a subregion may be distant from another subregion, or at least a part of a subregion may overlap at least with a part of another subregion. At least two light source units may correspond to one subregion. In other words, each of the plurality of light source units may correspond to any one of at least two subregions (less than the number of the light source units). The subregion to control the emission brightness of the light source unit may be different from the subregion for acquiring the profile data.

### EXAMPLE 2

Example 2 of the present invention will be described. In Example 1, a case of independently acquiring the profile data for each of the plurality of subregions was described. However, depending on the input image data, many types of profile data are acquired, and it takes time to acquire the profile data, or to refer to the profile data (to read data values from the profile data). As a result, an increase in the processing load, an increase in the processing time and the like may occur. In Example 2, an example of acquiring an effect similar to Example 1, while suppressing an increase in the processing load, an increase in the processing time and the like will be described. In the following, aspects (e.g. configuration, processing) that are different from Example 1 will be described in detail, and aspect that are the same as Example 1 will be omitted.

Profile Selecting Unit

A profile selecting unit 105 according to Example 2 acquires one profile data corresponding to a plurality of light source units, in accordance with the average gradation value of the input image data on the entire screen.

Method of Acquiring Profile Data

A concrete example of acquiring the profile data according to Example 2 will be described.

Step 4-1

First the profile selecting unit 105 calculates the average gradation value Vall of the input image data on the entire screen. The average gradation value Vall is an average value of all the gradation values of the input image data. For example, if the pixel values of the input image data are RGB values, the profile selecting unit 105 calculates the average gradation value Vall using the following Expression 8. In Expression 8, “Ri” denotes the R value of the i-th pixel, “Gi” denotes the G value of the i-th pixel, and “Bi” denotes the B value of the i-th pixel. “Z” denotes the total number of pixels of the input image data on the entire screen.

$$\begin{matrix}[ Math . 3 ] & \\ Vall = ( {\sum }_{i = 1}^{Z} Ri + Gi + Bi ) + Z & ( Expression 8 )\end{matrix}$$

Step 4-2

Then the profile selecting unit 105 selects and acquires the profile data corresponding to the acquired average gradation value Vall from a plurality of profile data stored in the profile storing unit 104.

Step 4-3

Then the profile selecting unit 105 outputs the acquired profile data to the distribution estimating unit 106.

As described above, according to Example 2, one profile data corresponding to a plurality of light source units is acquired and used in accordance with the average gradation value of the input image data on the entire screen. Thereby an effect similar to Example 1 can be acquired while suppressing an increase in the processing load, an increase in the processing time and the like.

Effects of Example 2 will be described in more detail.

In the prior art, fixed profile data which does not depend on the input image data is used as the profile data corresponding to a plurality of light source units. Therefore errors in the estimation result of the partial distribution, in the estimation result of the general distribution, correction parameters and the like may become major depending on the input image data.

In Example 2, profile data in accordance with the average gradation value of the input image data on the entire screen is used as the profile data corresponding to the plurality of light source units. Therefore only minor errors, which are caused in cases when each gradation value of the input image data is the same as the above mentioned average gradation value, are generated in the estimation result, the correction parameter and the like. As a consequence, errors can be reduced to minor errors, compared with the prior art, and a highly accurate estimation result, correction parameter and the like can be acquired.

Further, in Example 2, one common profile data is acquired for the plurality of light source units, and it is unnecessary to acquire a plurality of types of profile data, and to refer to a plurality of types or profile data, for example. Therefore an increase in the processing load, an increase in the processing time and the like can be suppressed.

In Examples 1 and 2, the input image data may be still image data or moving image data. If the input image data is moving image data, the processing in Example 1 or 2 are performed for each frame of the moving image data.

Each functional unit in FIG. 1 may or may not be independent hardware. The functions of at least two functional units may be implemented by common hardware. Each of a plurality of functions of one functional unit may be implemented by independent hardware. At least two functions of one functional unit may be implemented by common hardware. Each functional unit may or may not be implemented by hardware. For example, the apparatus may include a processor and a memory storing a control program. Then the functions of at least a part of the functional units of the apparatus may be implemented by a processor, reading, the control program from the memory, and executing the program.

Examples 1 and 2 are merely examples, and configurations implemented by appropriately modifying or changing the configuration of Example 1 or 2, within the scope of the essential content of the present invention, are also included in the present invention. Configurations implemented by appropriately combining the configurations of Examples 1 and 2 are also included in the present invention.

### Other Embodiments

Embodiment (s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e g. central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-028065, filed on Feb. 17, 2017, which is hereby incorporated by reference herein in its entirety.

What is claimed is:

1. An information processing apparatus configured to generate a correction parameter for correcting brightness of image data for a display apparatus which includes a light-emitting unit including a plurality of light source units, and a display unit configured to display an image on a screen by transmitting light emitted from the light-emitting unit based on the image data, the information processing apparatus comprising:
an acquiring unit configured to acquire, based on the image data, at least one profile data on a brightness distribution of light, which is emitted from the light source unit and is irradiated to the display unit, as at least one profile data corresponding to the plurality of light source units; and
a generating unit configured to generate the correction parameter based on the at least one profile data and emission brightness of each of the plurality of light source units.

2. The information processing apparatus according to claim 1, wherein
each of the plurality of light source units corresponds to any one of at least two subregions, which are respectively a part of a region of the screen, and
the acquiring unit acquires, for each of the at least two subregions, profile data on a light source unit corresponding to the subregion based on image data in the subregion.

3. The information processing apparatus according to claim 2, wherein
the plurality of light source units correspond to a plurality of subregions constituting the screen respectively.

4. The information processing apparatus according to claim 1, wherein
the acquiring unit acquires one profile data corresponding to the plurality of light source units in accordance with an average gradation value of the image data.

5. The information processing apparatus according to claim 1, wherein
a spread of a brightness distribution related to profile data, which is acquired in a case where the brightness of the image data is low, is larger than a spread of a brightness distribution related to profile data which is acquired in a case where the brightness of the image data is high.

6. The information processing apparatus according to claim 1, wherein
a plurality of profile data, which respectively correspond to a plurality of possible characteristic values of the image data, are provided in advance, and
the acquiring unit selects and acquires profile data corresponding to a characteristic value of the image data, out of the plurality of profile data.

7. The information processing apparatus according to claim 1, further comprising
a control unit configured to independently control the emission brightness of each of the plurality of light source units based on the image data.

8. The information processing apparatus according to claim 1, wherein
the generating unit:
estimates a general distribution, which is a brightness distribution of light which is emitted from the light-emitting unit and is irradiated to the display unit, based on the at least one profile data and the emission brightness of each of the plurality of light source units; and
generates the correction parameter based on the general distribution.

9. The information processing apparatus according to claim 8, wherein
the generating unit:
estimates, for each of the plurality of light source units, a partial distribution, which is the brightness distribution of the light which is emitted from the light source unit and is irradiated to the display unit, based on the profile data corresponding to the light source unit and the emission brightness of the light source unit; and
estimates the general distribution by combining a plurality of partial distributions which correspond to the plurality of light source units respectively.

10. The information processing apparatus according to claim 1, wherein
the information processing apparatus is the display apparatus.

11. An information processing method for generating a correction parameter for correcting brightness of image data for a display apparatus which includes a light-emitting unit including a plurality of light source units, and a display unit configured to display an image on a screen by transmitting light emitted from the light-emitting unit based on the image data, the information processing method comprising:
acquiring, based on the image data, at least one profile data on a brightness distribution of light, which is emitted from the light source unit and is irradiated to the display unit, as at least one profile data corresponding to the plurality of light source units; and
generating the correction parameter based on the at least one profile data and emission brightness of each of the plurality of light source units.

12. The information processing method according to claim 11, wherein
each of the plurality of light source units corresponds to any one of at least two subregions, which are respectively a part of a region of the screen, and
for each of the at least two subregions, profile data on a light source unit corresponding to the subregion is acquired based on image data in the subregion.

13. The information processing method according to claim 12, wherein
the plurality of light source units correspond to a plurality of subregions constituting the screen respectively.

14. The information processing method according to claim 11, wherein
one profile data corresponding to the plurality of light source units is acquired in accordance with an average gradation value of the image data.

15. The information processing method according to claim 11, wherein
a spread of a brightness distribution related to profile data, which is acquired in a case where the brightness of the image data is low, is larger than a spread of a brightness distribution related to profile data which is acquired in a case where the brightness of the image data is high.

16. The information processing method according to claim 11, wherein
a plurality of profile data, which respectively correspond to a plurality of possible characteristic values of the image data, are provided in advance, and
profile data corresponding to a characteristic value of the image data is selected and acquired out of the plurality of profile data.

17. The information processing method according to claim 11, further comprising
independently controlling the emission brightness of each of the plurality of light source units based on the image data.

18. The information processing method according to claim 11, wherein
a general distribution, which is a brightness distribution of light which is emitted from the light-emitting unit and is irradiated to the display unit, is estimated based on the at least one profile data and the emission brightness of each of the plurality of light source units; and
the correction parameter is generated based on the general distribution.

19. The information processing method according to claim 18, wherein
for each of the plurality of light source units, a partial distribution, which is the brightness distribution of the light which is emitted from the light source unit and is irradiated to the display unit, is estimated based on the profile data corresponding to the light source unit and the emission brightness of the light source unit; and
the general distribution is estimated by combining a plurality of partial distributions which correspond to the plurality of light source units respectively.

20. A non-transitory computer readable medium that stores a program, wherein
the program causes a computer to execute an information processing method for generating a correction parameter for correcting brightness of image data for a display apparatus which includes a light-emitting unit including a plurality of light source units, and a display unit configured to display an image on a screen by transmitting light emitted from the light-emitting unit based on the image data,
the information processing method includes:
acquiring, based on the image data, at least one profile data on a brightness distribution of light, which is emitted from the light source unit and is irradiated to the display unit, as at least one profile data corresponding to the plurality of light source units; and
generating the correction parameter based on the at least one profile data and emission brightness of each of the plurality of light source units.
